(19) United States
(12) Patent Application Publication
(10) Pub. No.: US 2019/0028978 A1
(43) Pub. Date: Jan. 24, 2019

(54) USER APPARATUS, BASE STATION, COMMUNICATION METHOD, AND COMMUNICATION INDICATION METHOD

(71) Applicant: NTT DOCOMO, INC., Tokyo (JP)

(72) Inventors: Shimpei Yasukawa, Tokyo (JP); Satoshi Nagata, Tokyo (JP); Qun Zhao, Beijing (CN)

(73) Assignee: NTT DOCOMO, INC., Tokyo (JP)

(21) Appl. No.: 15/755,736

(22) PCT Filed: Aug. 19, 2016
(86) PCT No.: PCT/JP2016/074262

§ 371 Date: Feb. 27, 2018

(30) Foreign Application Priority Data
Sep. 1, 2015 (JP) 2015-172393

(51) Int. Cl. H04W 52/24; H04W 52/36; H04W 92/18; H04W 8/00; H04W 56/00; H04W 4/70; H04B 17/309

(52) U.S. Cl. CPC H04W 52/24; H04W 52/367; H04W 92/18; H04W 80/02; H04W 56/001; H04W 4/70; H04B 17/309; H04W 8/005

(57) ABSTRACT

A user apparatus in a radio communication system that supports D2D communications includes an acquisition unit configured to acquire, from a base station, transmission power information including a candidate transmission power value of a D2D signal, and a transmission unit configured to change transmission power at each of predetermined periods, based on the candidate transmission power value included in the transmission power information, for transmitting a D2D signal.

### TECHNICAL FIELD

The present invention relates to a user apparatus, a base station, a communication method, and a communication indication method.

### BACKGROUND ART

In LTE (Long Term Evolution) and a successor system of LTE (e.g., also called LTE-A [LTE-Advanced], FRA [Future Radio Access], 4G, etc.), a D2D [Device to Device] technology that performs direct communications between user terminals without having intervention by a radio base station has been studied (e.g., Non-Patent Document 1). The D2D technology may be able to reduce the traffic between the user apparatuses and the base station and to enable communications between the user apparatuses even when the base station is no longer able to provide communication services at the time of disaster or the like.

The D2D technology is roughly divided into a D2D discovery for finding other communicative user terminals and a D2D communication for performing direct communications between the terminals (also referred to as a D2D direct communication, D2D communication, an inter-terminal direct communication, etc.). In the following, when the D2D technology is not specifically distinguished as the D2D communication, the D2D discovery etc., the D2D technology is simply called “D2D”. Further, a signal transmitted and received by the D2D is called a D2D signal.

In 3GPP (3rd Generation Partnership Project), it is being studied to implement V2X by extending the D2D function. Note that the V2X technology is a part of ITS (Intelligent Transport Systems), and is, as illustrated in FIG. 1, an all-inclusive term encompassing a V2V (Vehicle to Vehicle) indicating a communication mode between vehicles, a V2I (Vehicle to Infrastructure) indicating a communication mode between a vehicle and a roadside unit (RSU: Road-Side Unit) installed by the roadside, a V2N (Vehicle to Nomadic device) indicating a communication mode between a vehicle and a mobile terminal of a driver, and a V2P (Vehicle to Pedestrian) indicating a communication mode between the vehicle and the mobile terminal of the pedestrian.

### RELATED ART DOCUMENTS

### Non-Patent Documents

[NON-PATENT DOCUMENT 1] “Key drivers for LTE success: Services Evolution”, September 2011, 3GPP, the Internet URL: http://www.3gpp.org/ftp/Information/presentations/pr esentations_2011/9_09_LTE_Asia/2011_LTE-Asia_3GPP_Service_evolution.pdf
[NON-PATENT DOCUMENT 2] 3GPP TS36.213 V12.6.0 (2015-06)
[NON-PATENT DOCUMENT 3] 3GPP TS36.211 V12.6.0 (2015-06)

### SUMMARY OF THE INVENTION

### Problem to be Solved by the Invention

In V2X, it is assumed that small packets of approximately 50 to 1500 bytes are transmitted and received between user apparatuses. Furthermore, in V2V, it is assumed that packets of about 100 bytes are mainly transmitted and received between user apparatuses periodically (approximately 100 ms to 1 second) or by event triggers.

In V2X (especially V2V), there is a high possibility that transmission and reception of D2D signals will be performed in an environment where user apparatuses (automobiles) are relatively crowded, such as the center of a city or intersections. Accordingly, it is desired to provide a technique for reducing interference in D2D communications for securing D2D communications even in environments where many user apparatuses are present.

The disclosed technique is made in view of the above-described conditions, and it is an object of the present invention to provide a technology capable of controlling interference in D2D communications.

### Means for Solving the Problem

A user apparatus UE according to the disclosed technology is a user apparatus of a radio communication system that supports D2D communications, the user apparatus including an acquisition unit configured to acquire, from a base station, transmission power information including a candidate transmission power value of a D2D signal; and a transmission unit configured to change transmission power at each of predetermined periods, based on the candidate transmission power value included in the transmission power information, for transmitting a D2D signal.

### Advantageous Effect of Invention

According to the disclosed technology, there is provided a technology capable of controlling interference in D2D communications.

### BRIEF DESCRIPTION OF THE DRAWINGS

FIG. 1 is a diagram illustrating V2X;

FIG. 2A is a diagram illustrating D2D communications;

FIG. 2B is a diagram illustrating D2D communications;

FIG. 3 is a diagram illustrating an example of a channel structure for use in D2D communications;

FIG. 4A is a diagram illustrating a structural example of a PSDCH;

FIG. 4B is a diagram illustrating a structural example of a PSDCH;

FIG. 5A is a diagram illustrating a structural example of a PSCCH and a PSSCH;

FIG. 5B is a diagram illustrating a structural example of a PSCCH and PSSCH;

FIG. 6A is a diagram illustrating a resource pool configuration;

FIG. 6B is a diagram illustrating a resource pool configuration;

FIG. 7A is a diagram illustrating a structural example of a PSSS/SSSS;

FIG. 7B is a diagram illustrating a structural example of a PSSS/SSSS;

FIG. 8 is a diagram illustrating MAC PDU for use in D2D communications;

FIG. 9 is a diagram illustrating a format of an SL-SCH subheader;

FIG. 10 is a diagram illustrating a configuration example of a radio communication system according to an embodiment;

FIG. 11A is a diagram illustrating a transmission range of a D2D signal;

FIG. 11B is a diagram illustrating a transmission range of a D2D signal;

FIG. 11C is a diagram illustrating a transmission range of a D2D signal;

FIG. 12 is a diagram illustrating a change in transmission power of a user apparatus UE;

FIG. 13A is a diagram illustrating a unit for time-dependent switching of transmission power;

FIG. 13B is a diagram illustrating a unit for time-dependent switching of transmission power;

FIG. 13C is a diagram illustrating a unit for time-dependent switching of transmission power;

FIG. 14 is a sequence diagram illustrating an example of a process flow performed by the radio communication system according to the embodiment;

FIG. 15 is a diagram illustrating a functional configuration example of a user apparatus according to an embodiment;

FIG. 16 is a diagram illustrating a functional configuration example of a base station according to an embodiment; and

FIG. 17 is a diagram illustrating an example of a hardware configuration of the user apparatus and the base station according to the embodiment.

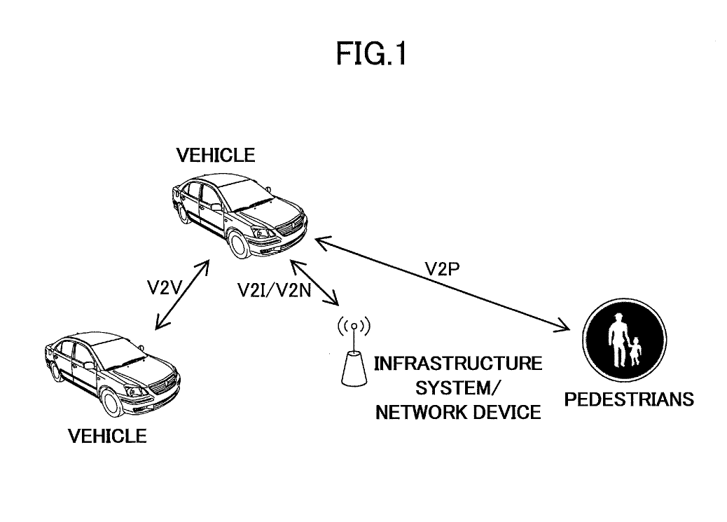

### EMBODIMENTS FOR CARRYING OUT THE INVENTION

The following describes embodiments of the present invention with reference to the accompanying drawings. Note that the embodiments described below are merely examples and the embodiments to which the present invention is applied are not limited to the following embodiments. For example, it is assumed that a radio communication system according to an embodiment complies with LTE standards. However, the present invention may be applied not limited to LTE but may also be applied to other systems. Note that, in the specification and the claims, the term “LTE” is used not only to mean a communication scheme corresponding to 3GPP release 8 or 9, but also to mean the fifth-generation mobile communication system corresponding to 3GPP release 10, 11, 12, 13, 14 or later.

Further, although a technology according to the present embodiment may be applied mainly to V2X, the application of the technology according to the present embodiment is not limited to V2X, and may be widely applicable to D2D in general. The term “D2D” is understood to include V2X in this sense.

Further, the “D2D” includes not only a process of transmitting and receiving a D2D signal between the user apparatuses UE but also includes a process of receiving (monitoring) the D2D signal by the base station, and a process of transmitting an uplink signal to the base station eNB by the user apparatus UE in a case where an RRC is idle or in a case where a connection with the base station eNB has not been established.

### Overview of D2D

The following first describes an overview of D2D defined in LTE. According to the D2D defined in LTE, each user apparatus UE performs signal transmission or reception using a part of an uplink resource already defined as a resource for uplink signal transmission from the user apparatus UE to the base station eNB.

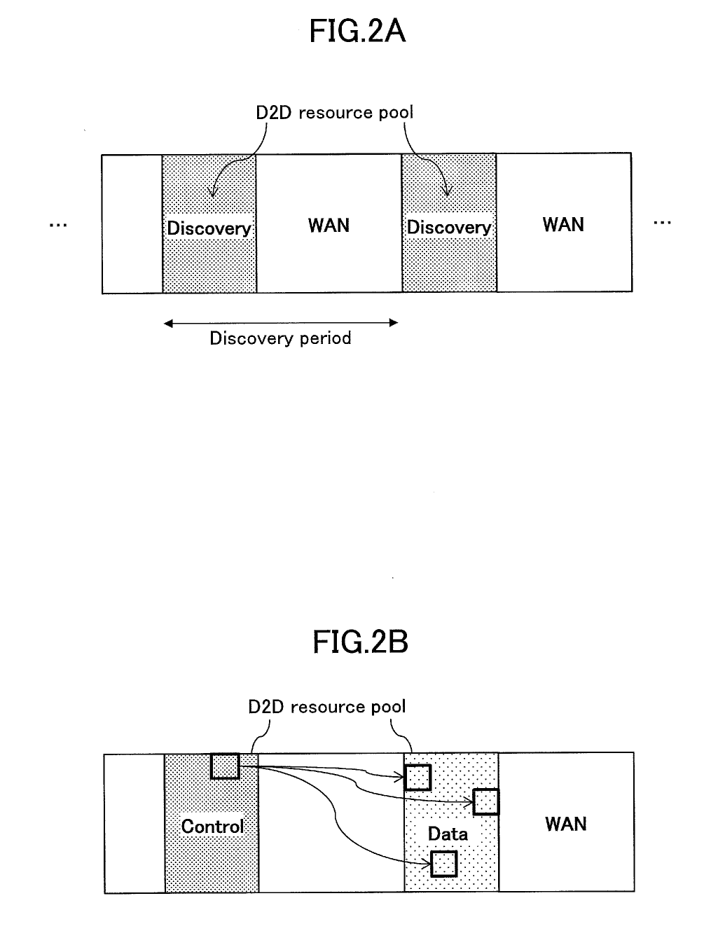

With respect to “Discovery”, as illustrated in FIG. 2A, a Discovery message resource pool is secured for each Discovery period, and the user apparatus UE transmits a Discovery message within the resource pool. More specifically, “Discovery” includes two “types”: Type 1 and Type 2b. In Type 1, the user apparatus UE autonomously selects transmission resources from the resource pool. In Type 2b, quasi-static resources are allocated by higher layer signaling (e.g., RRC signal).

With respect to “Communication”, as illustrated in FIG. 2B, a Control/Data transmission resource pool is periodically secured. The user apparatus UE serving as a transmitting end reports a Data transmission resource or the like via SCI (Sidelink Control Information) to a receiving end with a resource selected from the Control resource pool and transmits Data with the Data transmission resource. Specifically, in “Communication” there a Mode 1 and a Mode 2 as follows: In Mode 1, resources are dynamically allocated by an (E)PDCCH transmitted from the base station eNB to the user apparatus UE. In Mode 2, the user apparatus UE autonomously selects transmission resources from the Control/Data transmission resource pool. The resource pool used may be reported by SIB or a predefined resource pool may be used.

In LTE, the channel for use in “Discovery” is called PSDCH (Physical Sidelink Discovery Channel); in “Communication”, the channel for transmitting control information such as SCI is called PSCCH (Physical Sidelink Control Channel), and the channel for transmitting data is PSSCH (Physical Sidelink Shared Channel) (see Non-Patent Document 2).

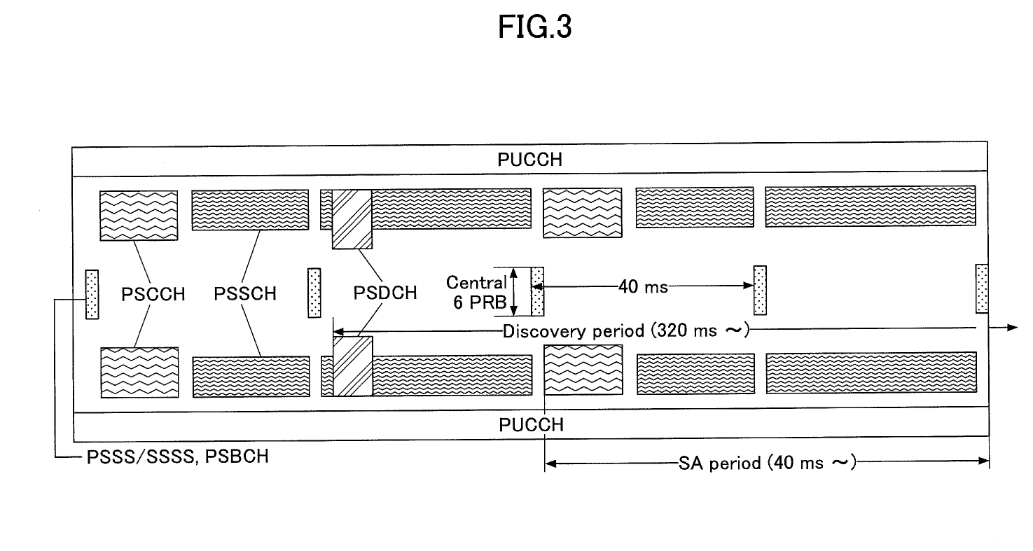

FIG. 3 illustrates an example of a channel structure of D2D. As illustrated in FIG. 3, PSCCH resource pools and PSSCH resource pools for use in Communication are allocated. In addition, a PSDCH resource pool for use in Discovery is allocated at a period longer than the periods of the channels of the Communication.

Further, PSSS (Primary Sidelink Synchronization) and SSSS (Secondary Sidelink Synchronization) are used as D2D synchronization signals. For example, a PSBCH (Physical Sidelink Broadcast Channel) that transmits broadcast information such as a D2D system band, a frame number, resource configuration information and the like is used for operations outside the coverage.

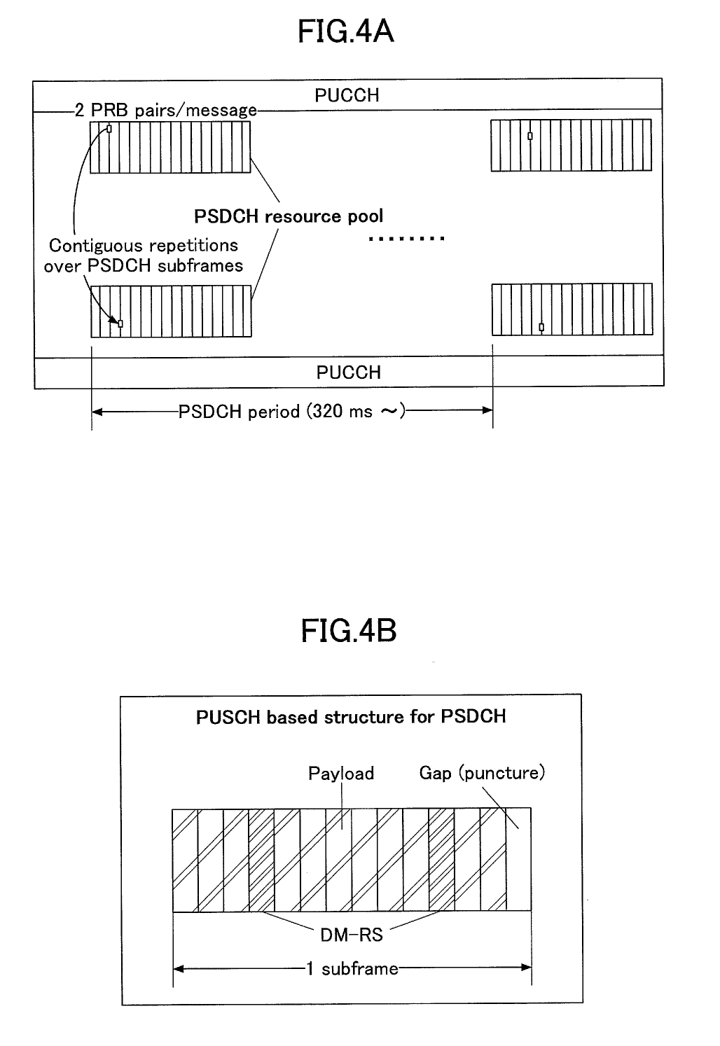

FIG. 4A illustrates an example of a PSDCH resource pool for use in Discovery. The resource pool is set by a subframe bitmap, which may be represented as an image of a resource pool as illustrated in FIG. 4A. Similar images may apply to resource pools for other channels. In PSDCH transmission, transmissions of the same signal are repeatedly performed (repetitions) with frequency hopping. The number of repetitions may be set, for example, from 0 to 4. As illustrated in FIG. 4B, PSDCH has a PUSCH based structure involving a DM-RS.

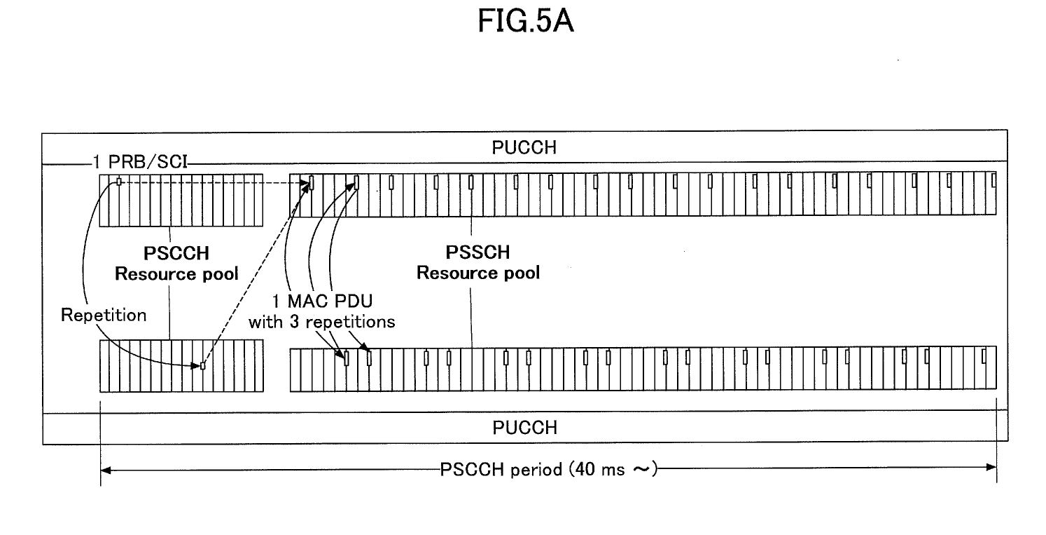

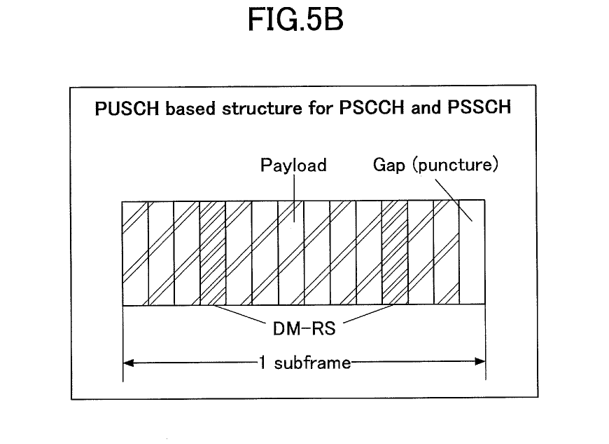

FIG. 5A illustrates examples of the PSCCH resource pool and PSSCH resource pool for use in “Communication”. As illustrated in FIG. 5A, in PSCCH transmission, transmission of the same signal is repeated once (one repetition) with frequency hopping. In PSSCH transmission, transmission of the same signal is repeated three times (three repetitions) with frequency hopping. As illustrated in FIG. 5B, PSCCH and PSSCH have a PUSCH based structure involving a DM-RS.

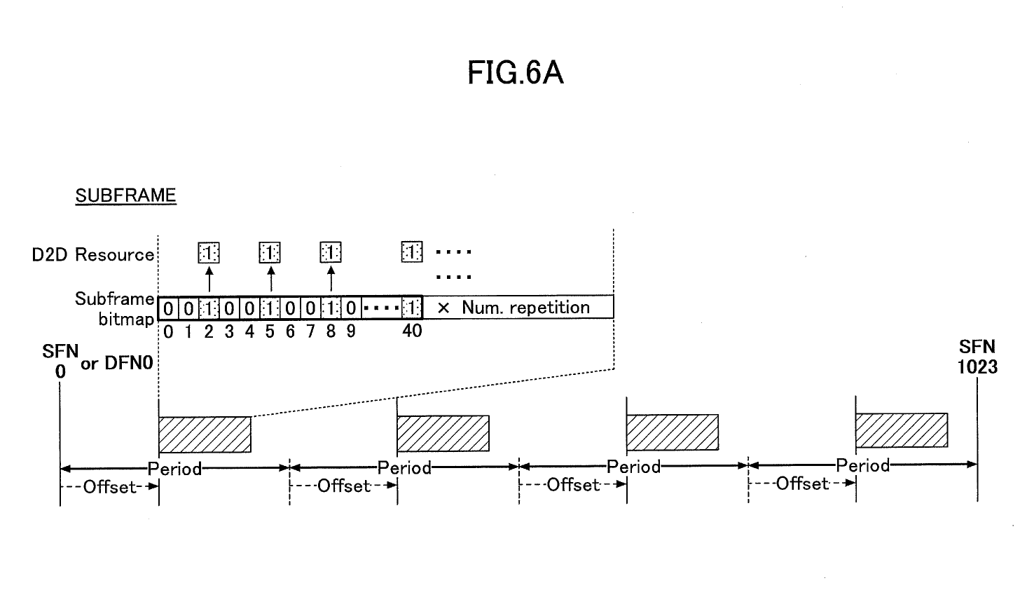

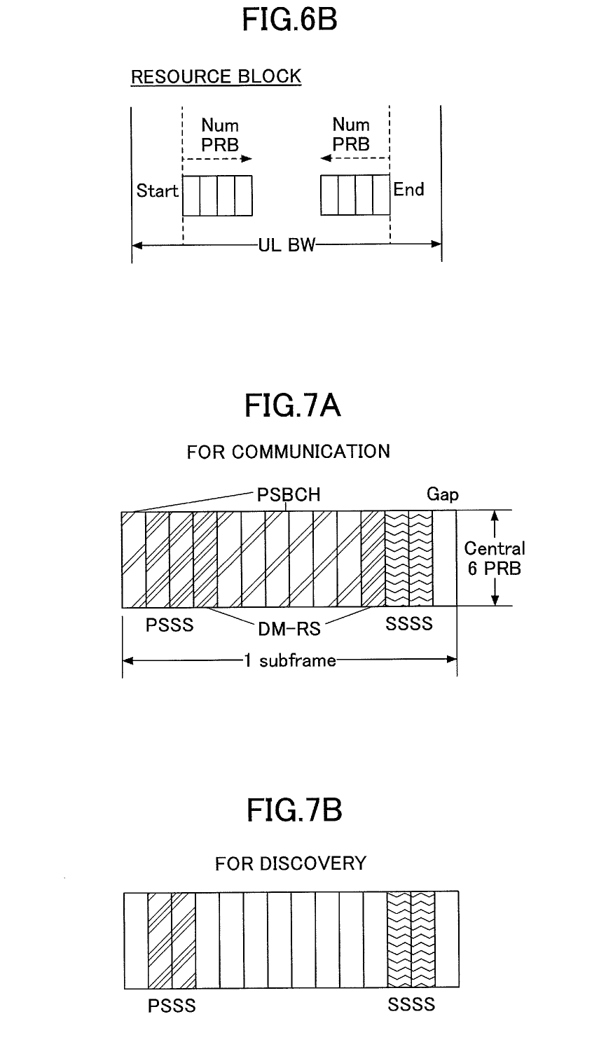

FIGS. 6A and 6B illustrate examples of resource pool configurations in PSCCH, PSDCH, and PSSCH (Mode 2). As illustrated in FIG. 6A, the resource pool is represented as a subframe bitmap in the time direction.

The bitmap is repeated by the number of times as indicated by “Num. repetitions”. Further, an offset indicating a start position of each period is specified.

Contiguous allocation and non-contiguous allocation may be applied in a frequency direction. FIG. 6B illustrates an example of non-contiguous allocation, in which a start PRB, an end PRB, and the number of PRBs (numPRB) are specified as illustrated.

FIGS. 7A and 7B illustrate PSSS/SSSS. FIG. 7A illustrates an example of a synchronization subframe in communication. As illustrated in FIG. 7A, PSSS, SSSS, DM-RS, and PSBCH are multiplexed. FIG. 7B illustrates an example of a synchronization subframe in Discovery. As illustrated in FIG. 7B, PSSS and SSSS are multiplexed.

The PSBCH includes a DFN (D2D frame number), a TDDUL-DL configuration, In-coverage indicator, a system bandwidth, a reserved field, and the like.

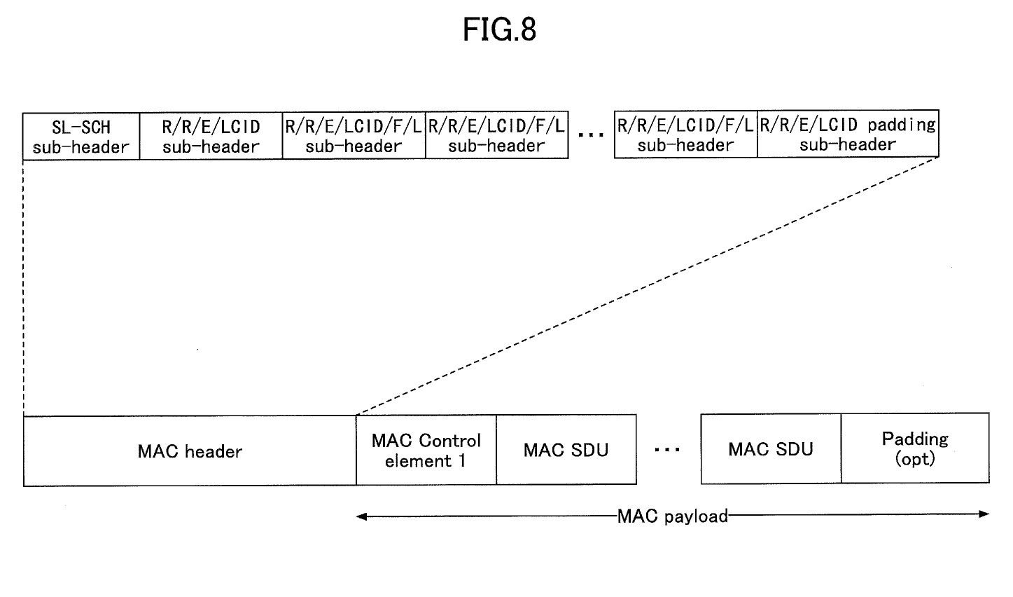

As illustrated in FIG. 8, MAC (Medium Access Control) PDU (Protocol Data Unit) for use in the D2D communication includes at least a MAC header, MAC Control element, MAC SDU (Service Data Unit), and Padding. The MAC PDU may contain other information. The MAC header includes one SL-SCH (Sidelink Shared Channel) subheader and one or more MAC PDU subheaders.

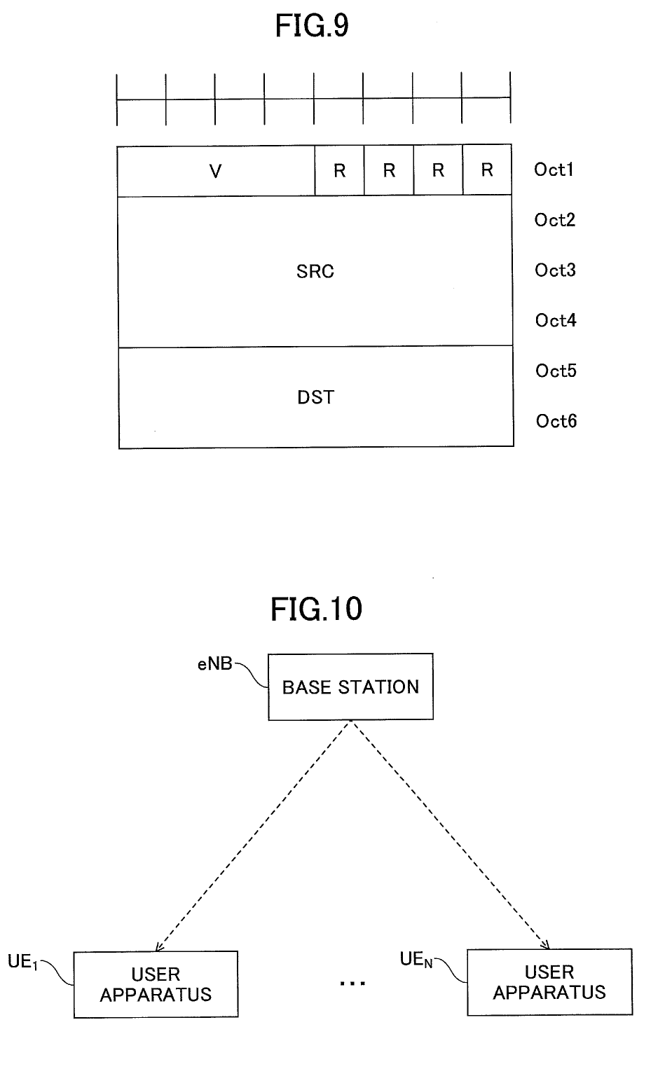

As illustrated in FIG. 9, the SL-SCH subheader includes a MAC PDU format version (V), transmission source information (SRC), transmission destination information (DST), Reserved bit (R) and the like. V is allocated to the head of the SL-SCH subheader and indicates a MAC PDU format version used by the user apparatus UE. Information related to the transmission source is set as transmission source information. An identifier for ProSeUEID may be set in the transmission source information. Information related to the transmission destination is set as transmission destination information. Information on ProSeLayer-2 Group ID of a transmission destination may be set as the transmission destination information.

### System Configuration

FIG. 10 is a diagram illustrating a configuration example of a radio communication system according to an embodiment. As illustrated in FIG. 10, the radio communication system according to the embodiment has a base station eNB and user apparatuses UE₁ to UE_{N}. In the following description, the user apparatuses UE₁ to UE_{N} are referred to as “user apparatus UE” unless the user apparatuses UE₁ to UE_{N} are distinguished from one another.

The user apparatus UE has a cellular communication function and a D2D communication function. In addition, the base station eNB has a function to perform various instructions (resource pool setting, D2D resource allocation, etc.) necessary for transmitting and receiving the D2D signal to the user apparatus UE.

The user apparatus UE according to the present embodiment includes a vehicle defined in V2X, a mobile terminal of a driver, and a mobile terminal of a pedestrian. In addition, the RSU defined in V2X may be a user apparatus UE or a base station eNB in the present embodiment unless otherwise specified.

### Operational Overview

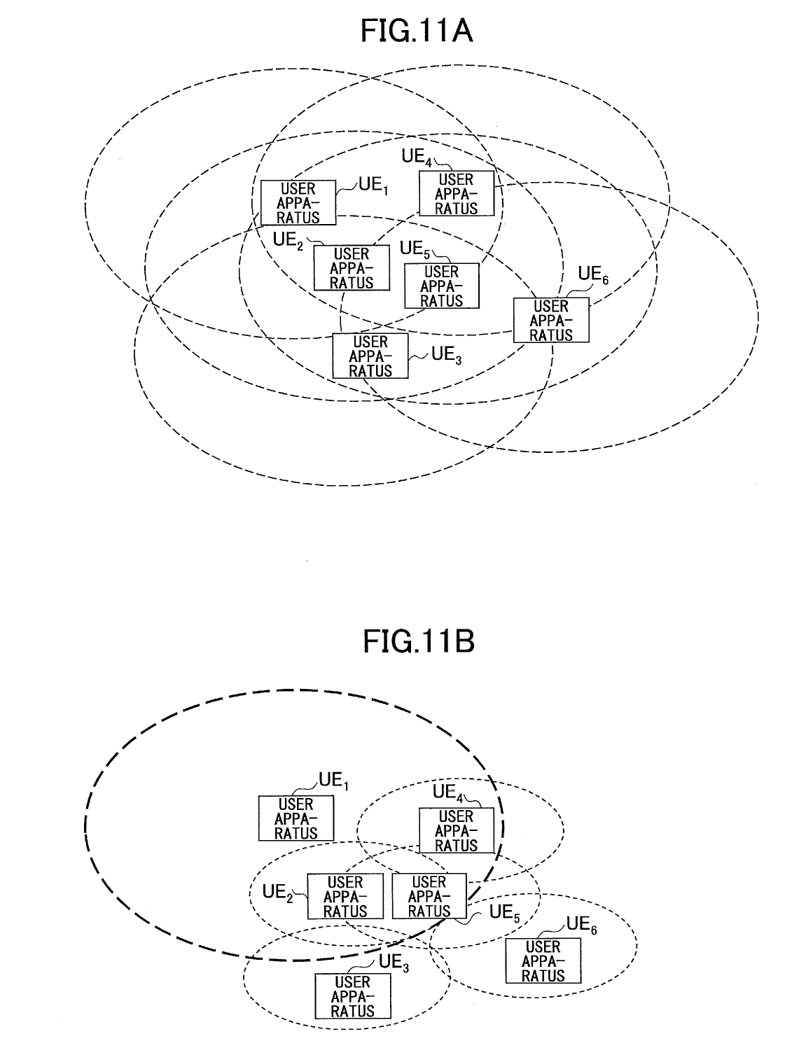

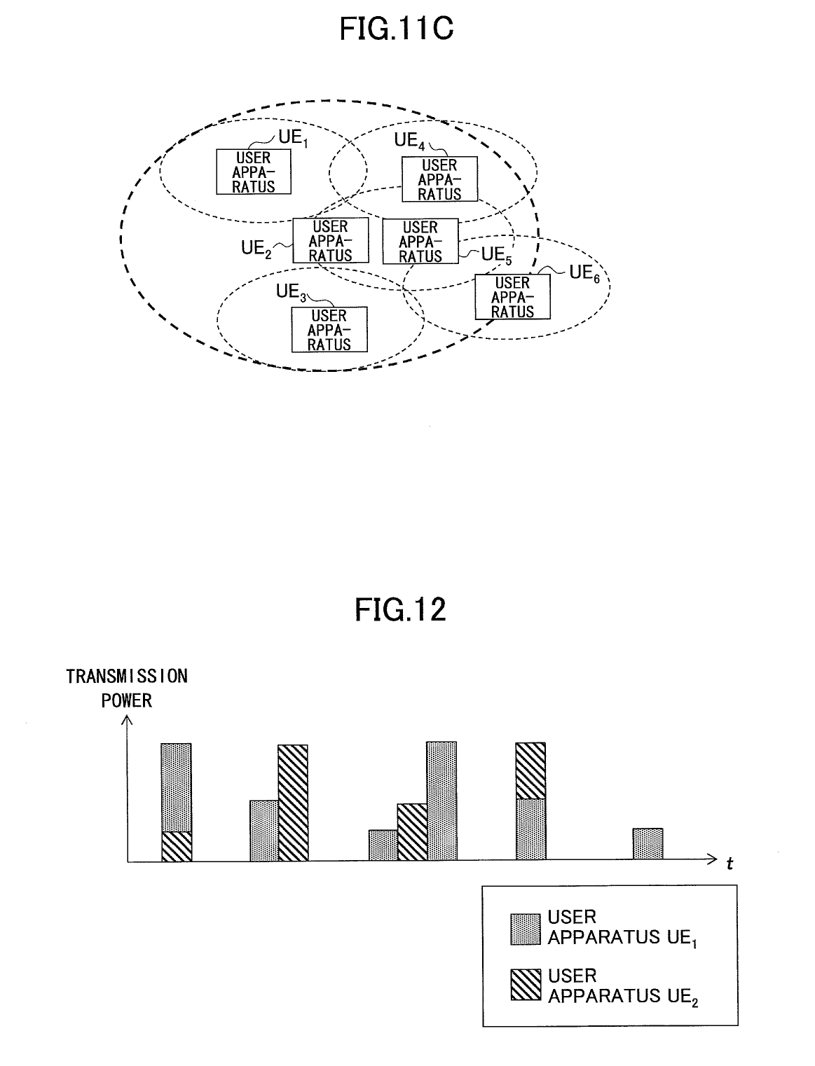

In V2X, it is assumed that D2D signals are transmitted and received in a crowded environment in which a large number of user apparatuses UE are present, such as the center of a city or intersections. Hence, it is assumed that a large number of user apparatuses UE simultaneously transmit D2D signals at a short distance, leading to occurrence of interference between D2D signals and packet collision (mainly collisions occurring when D2D signals are transmitted with the same radio resource mainly in mode 2, etc.). When each of the user apparatuses UE₁ to UE₆ transmits a D2D signal with approximately the same and relatively high transmission power, the D2D signal is transmitted across a wide range as illustrated, for example, in FIG. 11A, which may increase the occurrence of interference and packet collision.

In the present embodiment, the transmission power with which each user apparatus UE transmits the D2D signal is randomized within the radio communication system. Specifically, each user apparatus UE transmits a D2D signal by time-dependent switching of the transmission power.

FIG. 11B illustrates an example in which a user apparatus UE₁ transmits a D2D signal with high transmission power at a certain timing whereas the user apparatuses UE₂ to UE₆ transmit a D2D signal with low transmission power. Likewise, FIG. 11C illustrates an example in which the user apparatus UE₂ transmits a D2D signal with high transmission power at a certain timing whereas the user apparatus UE₁ and the user apparatuses UE₃ to UE₆ transmit a D2D signal with low transmission power. The user apparatuses UE₃ to UE₆ transmits a D2D signal by time-dependent switching of the transmission power in manners similar to those described above.

Accordingly, as compared with the transmission range of the example illustrated in FIG. 11A for the examples illustrated in FIGS. 11B and 11C, a transmission range of the D2D signal transmitted from each user apparatus UE is restricted, which may result in controlling the occurrence of interference and packet collision. In addition, by controlling the occurrence of interference and packet collision, it is possible to prevent an increase in latency in communications. Further, it becomes possible to achieve D2D communication that can compatibly meet needs for low latency over communication distance conservation such as for critical communications that prevent accidents, and yet at the same time can meet preferences to conserve communication distance even, to some extent, over lower latency.

FIGS. 11A, 11B, and 11C illustrate an example where only one user apparatus UE transmits a D2D signal with high transmission power, for simplifying the description; however, the embodiment is not limited to these examples. When the transmission power of each user apparatus UE is randomized, multiple user apparatuses UE may transmit a D2D signal with high transmission power in accordance with a congested situation. FIG. 12 is a diagram illustrating an example of time-dependent changes in transmission power. Note that FIG. 12 illustrates time-dependent changes in transmission power in the user apparatus UE₁ and the user apparatus UE₂; however, the user apparatus UE₃ to the user apparatus UE_{N} similarly transmit the D2D signals with time-dependent changing of the transmission power.

An example of the later-described process is based on the assumption that PSCCH and PSSCH are transmitted using respective independent resource pools; however, the embodiment of the present invention is not limited to this example. This embodiment may also be applied to an example in which a new channel/resource pool is defined, and control information/data is transmitted in the same subframe and/or consecutive subframes using the newly defined channel/resource pool.

### Process Flow

### Temporal Switching of Transmission Power

In the present embodiment, the user apparatus UE transmits a D2D signal with time-dependent switching of the transmission power at each of predetermined periods.

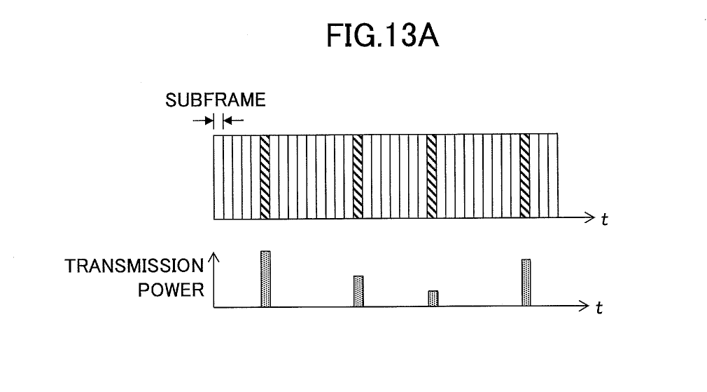

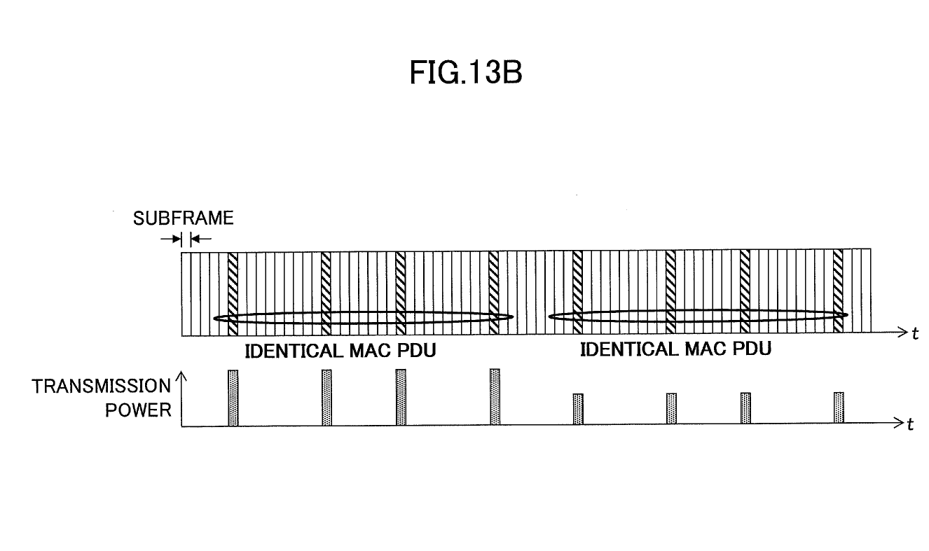

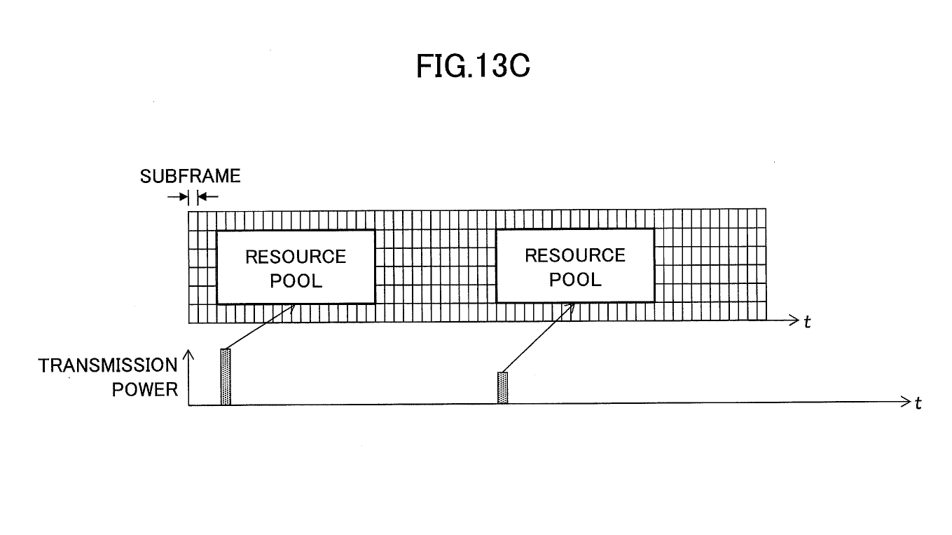

FIGS. 13A, 13B, and 13C are diagrams illustrating a unit for time-dependent switching of the transmission power. For example, as illustrated in FIG. 13A, the user apparatus UE may switch transmission power with respect to a subframe unit for transmitting D2D signals. In D2D, the identical MAC PDU is repeatedly transmitted four times as illustrated in FIG. 5A. As illustrated in FIG. 13B, the user apparatus UE may thus switch the transmission power with respect to a unit of repetitively transmitting an identical MAC PDU in the PSSCH. In D2D, as illustrated in FIGS. 4A and 5A, a D2D signal is transmitted among preset periodic resource pools (PSDCH resource pool, PSSCH resource pool, and PSSCH resource pool). Hence, as illustrated in FIG. 13C, the user apparatus UE may switch the transmission power with respect to a unit of a periodically reset resource pool. FIGS. 13A, 13B, and 13C illustrate examples in which the D2D signal is transmitted with respect to a subframe unit; however, FIGS. 13A, 13B, and 13C may also include an example where the D2D signal is transmitted in slot units or in one or multiple symbol units.

Note that whichever the switching period units illustrated in FIG. 13A, FIG. 13B and FIG. 13C is to be applied may be indicated from the base station eNB to the user apparatus UE by RRC signal or broadcast information (SIB). Alternatively, one or multiple setting values indicating a unit of the switching period to be applied may be set in the user apparatus UE in advance, and the user apparatus UE may optionally determine a desired one of the setting values among the setting values, or the user apparatus UE may determine a unit of the switching period without selecting the setting value. Further, a unit of the switching period differing for each of the D2D physical channels (PSDCH, PSDCH, PSSCH, PSSS/SSSS, and PSBCH) may be applied.

Several embodiments will now be described with respect to a method by which the user apparatus UE determines the transmission power in each switching period.

### Determination of Transmission Power (Part 1)

First, a method for determining transmission power to be applied in each switching period in accordance with a predetermined transmission power pattern will be described. The transmission power pattern may, for example, include two or more candidate transmission power values such as “23 dBm, 20 dBm, and 13 dBm” in advance. There is no limitation to the number of candidate transmission power values included in the transmission power pattern.

[1-1]

The user apparatus UE may switch the transmission power in accordance with an order for the candidate transmission power values in the transmission power pattern at each switching period. For example, in a case where the order of the candidate transmission power values is “23 dBm, 20 dBm, and 13 dBm” and the unit of transmission power switching period is a subframe unit, the user apparatus UE switches the transmission power in the order of 23 dBm, 20 dBm, 13 dBm, 23 dBm, 20 dBm, 13 dBm, and the like for each subframe.

[1-2]

The user apparatus UE may randomly select the transmission power from a transmission power pattern. For example, in a case where the unit of the switching period is a subframe unit, the user apparatus UE optionally selects transmission power from “23 dBm, 20 dBm, and 13 dBm” for each subframe and transmits the D2D signal. In addition, the user apparatus UE may store the selected transmission power such that the same transmission power is not selected consecutively from a transmission power pattern.

[1-3]

The user apparatus UE may determine the candidate transmission power value to be selected a the transmission power pattern based on the setting value of SCI (Time Resource Pattern, MCS, TA, Group Destination ID, etc.).

For example, the user apparatus UE may generate a pseudo random number using the setting value of the SCI as a “seed value”, and may select one candidate transmission power value from the transmission power pattern in accordance with the value of the generated pseudo random number. Specifically, in a case where the order of the candidate transmission power values is “23 dBm, 20 dBm, and 13 dBm” and the value of the pseudo random number is 1, the user apparatus UE selects 23 dBm. In a case where the order of the candidate transmission power values is “23 dBm, 20 dBm, and 13 dBm” and the value of the pseudo random number is 2, the user apparatus UE selects 20 dBm. In a case where the order of the candidate transmission power values is “23 dBm, 20 dBm, and 13 dBm” and the value of pseudo random number is 3, the user apparatus UE selects 13 dBm.

As another specific example, it is assumed that the order of candidate values of transmission power is “23 dBm, 20 dBm, and 13 dBm” and the unit of switching period of transmission power is in subframe unit. In a case where the value of the pseudo random number is 1, the user apparatus UE may switch the transmission power in the order of 23 dBm, 20 dBm, 13 dBm, 23 dBm, 20 dBm, 13 dBm, etc. for each subframe. In a case where the value of the pseudo random number is 2, the user apparatus UE may switch the transmission power in the order of 20 dBm, 13 dBm, 23 dBm, 20 dBm, 13 dBm, 23 dBm, etc. for each subframe. In a case where the value of the pseudo random number is 3, the user apparatus UE may switch the transmission power in the order of 13 dBm, 23 dBm, 20 dBm, 13 dBm, 23 dBm, 20 dBm, etc. for each subframe.

By previously holding the same transmission power pattern and pseudo random number algorithm between the user apparatus UE serving as a receiving end and the user apparatus UE serving as a transmitting end, the receiving end user apparatus UE may be able to estimate the actual transmission power of the D2D signal in the PSSCH for each switching period based on the setting value of the received SCI. Note that a similar process may be achieved by selecting the transmission power pattern corresponding to the hash value generated by using the setting value of the SCI instead of the value of the pseudo random number.

In addition, the receiving end user apparatus UE may be enabled to determine a timing (subframe) of receiving the PSSCH, estimate the path loss, and estimate a distance between the transmitting end user apparatus UE and the receiving end user apparatus itself, on the basis of the estimated transmission power and transmission power pattern.

[1-4]

The user apparatus UE may select the transmission power pattern in accordance with the state of the user apparatus UE itself and/or the transmission data type, the measurement result, and the like. For example, a user apparatus UE that is moving at a high speed may constantly use transmission power of 23 dBm, and a user apparatus UE moving at a low speed may determine the transmission power using a transmission power pattern, including low transmission power values, such as “23 dBm, 20 dBm, and 13 dBm” or the like. Alternatively, the user apparatus UE may determine the transmission power in accordance with the identifier indicated by the upper layer, or may limit the applicable transmission power pattern in accordance with the Measurement result. The thresholds and/or multiple sets of transmission power patterns may be set in advance from the base station eNB for the above-described operations.

### Setting of Transmission Power Pattern

As the transmission power pattern, the same (common) transmission power pattern may be applied between the user apparatuses UE. The transmission power will be randomized in terms of time even in a case where the same transmission power pattern is applied to the different user apparatuses UE. This is because the subframe that transmits the D2D signal differs for each of the user apparatuses UE.

Alternatively, different transmission power patterns may be applied to the different user apparatuses UE. In the case where different transmission power patterns are applied to the different user apparatuses UE, a transmission power pattern in which the identical setting value is shifted in time may be applied to each of the user apparatuses UE. For example, for three transmission power patterns of “23 dBm, 20 dBm, and 13 dBm”, “20 dBm, 13 dBm, and 23 dBm”, and “13 dBm, 23 dBm, and 20 dBm” are set in advance, any one of the three transmission power patterns may be applied to each of the user apparatuses UE.

Further, a different transmission power pattern may be applied to each of the D2D physical channels (PSDCH, PSCCH, and PSSCH), or a common transmission power pattern may be applied to each of the D2D physical channels.

### Modification of Transmission Power Pattern

For the transmission power pattern, a power density candidate value may be set instead of a candidate transmission power value. A unit of the power density to be set is not particularly specified; however, the unit of the power density may be, for example, the transmission power per 1 PRB (Physical Resource Block) (180 kHz), or may be the transmission power per subcarrier (15 kHz). In this case, the user apparatus UE calculates the actual transmission power based on the bandwidth of the D2D signal transmitted in each subframe.

The path loss compensation term (a) in the transmission power control (Fractional TPC (Transmission Power Control)) may be set for the transmission power pattern instead of the candidate transmission power value. Alternatively, a target received power Po may be set, or an offset value (back-off value) with respect to the transmission power (P) may be set. In this case, the user apparatus UE may calculate the actual transmission power (P) using the following equation. In the following equation (1), “PL” represents the downlink path loss (propagation loss) from the base station eNB, and “M” represents the transmission power per PRB. “PC_{MAX}” represents the maximum transmission power determined based on the power class (Power Class) etc. of the user apparatus UE.

P=min{P_{CMAX},10 log₁₀(M)+P_{O}+α·PL} (1)

### Determination of Transmission Power (Part 2)

The user apparatus UE may optionally determine transmission power applied in each switching period within a range not exceeding the maximum transmission power. The maximum transmission power may be PC_{MAX} or may be the maximum transmission power specified by the base station eNB.

Further, the user apparatus UE may determine transmission power to be applied in each of the switching periods so as not to exceed a predetermined total transmission power per predetermined unit. For example, the total transmission power for each resource pool is specified as “23 dBm×10 (subframe)×6 PRB” in advance, and the user apparatus UE may determine the transmission power for each of the subframes such that the total transmission power of the D2D signals to be transmitted within one resource pool will not exceed the specified total transmission power.

The determination of the transmission power (part 1) and (part 2) have been described above; however, a value (e.g., −∞) indicating no transmission may be included among the candidate transmission power values included in the above transmission power pattern, or the number of Repetition transmission times may be controlled using a value indicating no transmission. For example, in a case where a value indicating non-transmission is selected and/or the transmission power is low, the transmission of the D2D signal may be dropped and a D2D signal may be received in the subframe from which the transmission has been dropped. The above-described method may prevent the application of extremely low transmission power and avoid an adverse effect of Halfduplex.

### Processing Sequence

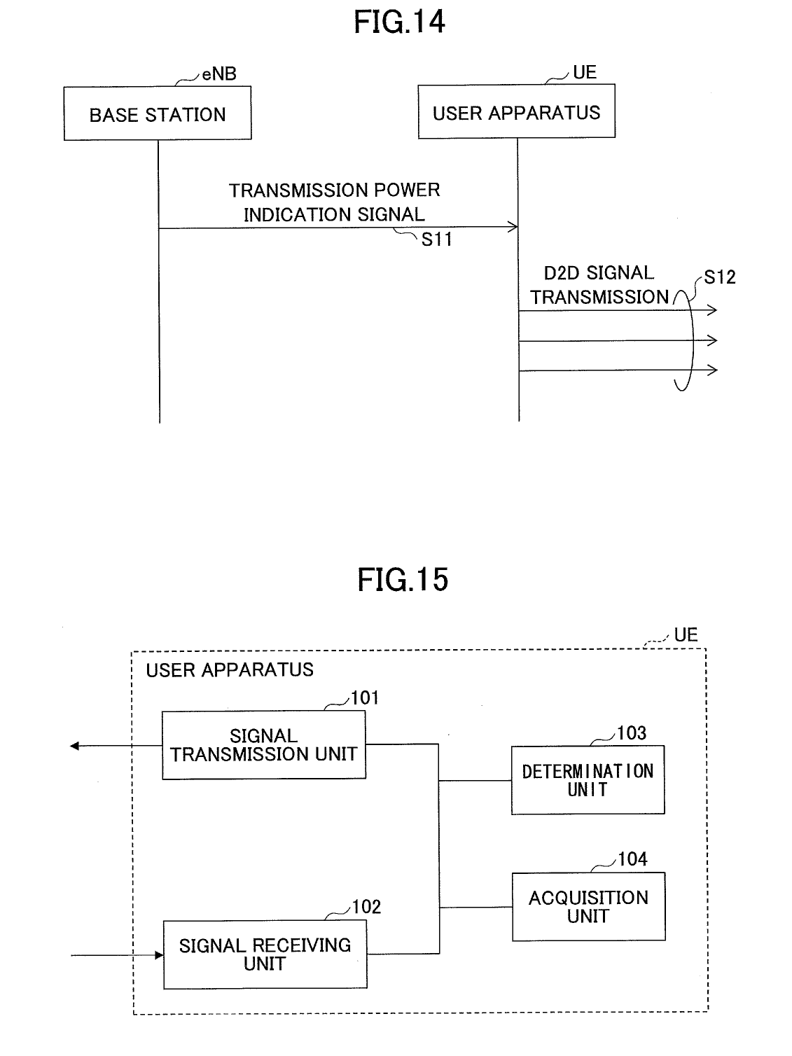

FIG. 14 is a sequence diagram illustrating an example of a process flow performed by the radio communication system according to the embodiment.

In step S11, the base station eNB transmits a transmission power indication signal to the user apparatus UE. The transmission power indication signal includes a transmission power pattern, the maximum transmission power or a total transmission power. The base station eNB may transmit the same transmission power pattern to each of the user apparatuses UE or may transmit different transmission power patterns to the different user apparatuses UE. The transmission power indication signal may be an RRC signal or broadcast information (SIB). The transmission power instruction signal may also be a layer 2 signal or a layer 1 signal.

Note that the base station eNB may select a candidate transmission power value to be included in the transmission power pattern that is scheduled to be transmitted to the user apparatus UE, based on information previously fed back from the user apparatus UE.

For example, the user apparatus UE may feed back the minimum transmission power desired by the user apparatus UE, and the base station eNB may select multiple candidate transmission power values within a range that satisfies the fed back minimum transmission power. Specifically, in a case where the fed back minimum transmission power is 10 dBm and the PC_{MAX} of the user apparatus UE is 23 dBm, the base station eNB may select multiple candidate transmission power values (10 dBm, 15 dBm, 20 dBm, 23 dBm, etc.) within a range of 10 to 23 dBm.

The user apparatus UE may determine the minimum transmission power to be fed back to the base station eNB in accordance with the moving speed of the user apparatus UE itself. For example, the user apparatus UE may reduce the minimum transmission power when the moving speed of the user apparatus UE itself is low, and may increase the minimum transmission power when the moving speed of the user apparatus UE itself is high. The user apparatus UE may determine the minimum transmission power to be fed back to the base station eNB in accordance with the current position of the user apparatus UE itself. For example, in a relatively crowded environment such as the center of a city or intersections, the minimum transmission power may be kept low whereas in a relatively uncrowded environment such as suburbs, the minimum transmission power may be increased.

In step S12, the user apparatus UE uses the transmission power pattern acquired through the transmission power indication signal, the maximum transmission power or the total transmission power to transmit D2D signals with time-dependent switching of the transmission power in accordance with the above “determination of transmission power (part 1)” or the “determination of transmission power (part 2)”.

Note that the user apparatus UE may include information indicating the actual transmission power in the SCI, the MAC header, or the like when transmitting the D2D signal. The receiving end user apparatus UE may estimate path loss, or may estimate the distance between the receiving end user apparatus itself and the transmitting end user apparatus UE, based on such information indicating the actual transmission power.

The receiving end user apparatus UE may determine the candidate transmission power value to be selected from the transmission power pattern based on the setting value of the SCI when transmitting the D2D signal.

When transmitting the D2D signal, the user apparatus UE may apply a different DM-RS sequence determined in advance for each of the candidate transmission power values. For example, it is assumed for the following that the user apparatus UE selects any one of the candidate transmission power values from “23 dBm, 20 dBm, and 13 dBm” for each of the subframes to transmit the D2D signal. In this case, the user apparatus UE transmits a D2D signal using a DM-RS sequence corresponding to 23 dBm when transmitting a D2D signal at 23 dBm; the user apparatus UE transmits a D2D signal using a DM-RS sequence corresponds to 20 dBm when transmitting a D2D signal at 20 dBm; and the user apparatus UE transmits a D2D signal using a DM-RS sequence corresponding to 13 dBm when transmitting the D2D signal at 13 dBm. Accordingly, the receiving end user apparatus UE may perform blind demodulation of the DM-RS to specify the DM-RS sequence to specify the transmission power, such that the receiving end user apparatus UE may be enabled to specify the transmission power when the transmitting end user apparatus UE transmits the D2D signal. The receiving end user apparatus UE may also be enabled to estimate the path loss, estimate the distance between the receiving end user apparatus UE itself and the transmitting end user apparatus UE, and the like, based on the specified transmission power.

Switching in Accordance with Congestion
Note that switching control of the transmission power in the present embodiment may be applied only when the area (cell) is congested.

For example, the base station eNB may transmit a transmission power indication signal to the user apparatus UE only when the cell managed by the base station eNB is congested, and the user apparatus UE may execute the switching control of the transmission power in the present embodiment only when the user apparatus UE has received the transmission power instruction signal.

Note that the base station eNB may determine that the cell managed by the base station eNB is congested when the number of user apparatuses (UEs) residing within (connected to) the cell managed by the base station eNB exceeds a predetermined threshold, or may determine that the cell managed by the base station eNB is congested based on a report from the user apparatus UE.

The user apparatus UE may be allowed to determine whether the area is congested. A transmission power indication signal may be transmitted in advance from the base station eNB to the user apparatus UE, and when the user apparatus UE determines that the area is congested, the user apparatus UE may transmit the D2D signal with time-dependent switching of the transmission power in accordance with the above-described “determination of the transmission power (part 1)” or “determination of the transmission power (part 2)”.

Note that the user apparatus UE may determine that the area surrounding the user apparatus UE itself is congested in a case where the mean received power or the interference wave level of the D2D signal received from another user apparatus UE exceeds a predetermined threshold. The predetermined threshold included in the transmission power indication signal may be transmitted from the base station eNB to the user apparatus UE.

Note that the switching control mode of the transmission power in the present embodiment may be applied only when the area (cell) is congested. For example, the base station eNB may transmit, to the user apparatus UE, a signal (RRC signal, etc.) indicating the start and the end of switching control mode of the transmission power in this embodiment, and the user apparatus UE may determine based on the indication from the signal whether to execute the switching control mode of transmission power in the present embodiment.

### Functional Configuration

The following illustrates examples of functional configurations of the user apparatus UE and the base station eNB that perform the operations of the above-described embodiment.

### User Apparatus

FIG. 15 is a diagram illustrating a functional configuration example of a user apparatus according to an embodiment. As illustrated in FIG. 15, the user apparatus UE includes a signal transmission unit 101, a signal receiving unit 102, a determination unit 103, and an acquisition unit 104. Note that FIG. 15 merely illustrates the functional configuration particularly related to the embodiment of the present invention in the user apparatus UE, and the user apparatus UE may also include not-illustrated functions for performing, at the least, operations in compliance with LTE. The functional configuration of the user apparatus UE illustrated in FIG. 15 is merely an example. Any functional division and any names of the functional components may be applied insofar as the operations according to the present embodiment may be executed.

The signal transmission unit 101 includes a function to generate various types of signals of the physical layer from the signals of a higher layer to be transmitted from the user apparatus UE and to wirelessly transmit the generated signals. The signal transmission unit 101 further includes a function to transmit a D2D signal and a function to transmit a signal in a cellular communication system. The signal transmission unit 101 has a function to change transmission power at each of predetermined periods (at predetermined periodical intervals), based on the candidate transmission power value included in the transmission power pattern, for transmitting a D2D signal. Note that the unit of the predetermined period may be a subframe unit for transmitting the D2D signal, a unit for repeatedly transmitting the identical MAC PDU or a resource pool unit for use in the D2D signal. Further, when multiple candidate transmission power values are included in the transmission power pattern, the signal transmission unit 101 changes the transmission power in accordance with the candidate value selected from the multiple candidate transmission power values at each of predetermined periods to transmit the D2D signal. The signal transmission unit 101 may change the transmission power at a different period (at different periodical intervals) for each of the D2D physical channels. The signal transmission unit 101 may determine the transmission power of the D2D signal transmitted with the PSSCH based on the setting value of the SCI transmitted with the PSSCH.

The signal transmission unit 101 may feed back a desired minimum transmission power to the base station eNB. The signal transmission unit 101 may select the minimum transmission power based on the moving speed, the current position or the like of the user apparatus UE itself.

The signal receiving unit 102 includes a function to wirelessly receive various signals from another user apparatus UE or the base station eNB, and a function to acquire signals of a higher layer from the received signals of the physical layer. The signal receiving unit 102 further includes a function to receive the D2D signal and a function to receive a signal in the cellular communication system.

The determination unit 103 includes a function to measure the mean received power or the interference wave level of the D2D signal from the other user apparatus UE received by the signal receiving unit 102, and also includes a function to determine whether the measured mean received power or interference wave level exceeds a predetermined threshold. When the determination unit 103 determines that the measured mean received power or interference wave level exceeds the predetermined threshold, the determination unit 103 indicates to the signal transmission unit 101 that the signal transmission unit 101 transmits the D2D signal by changing the transmission power at each of predetermined periods (at predetermined periodical intervals).

The acquisition unit 104 includes a function to acquire a transmission power pattern including a candidate transmission power value of the D2D signal from the base station via the signal receiving unit 102. The acquisition unit 104 transfers the acquired transmission power pattern to the signal transmission unit 101.

### Base Station

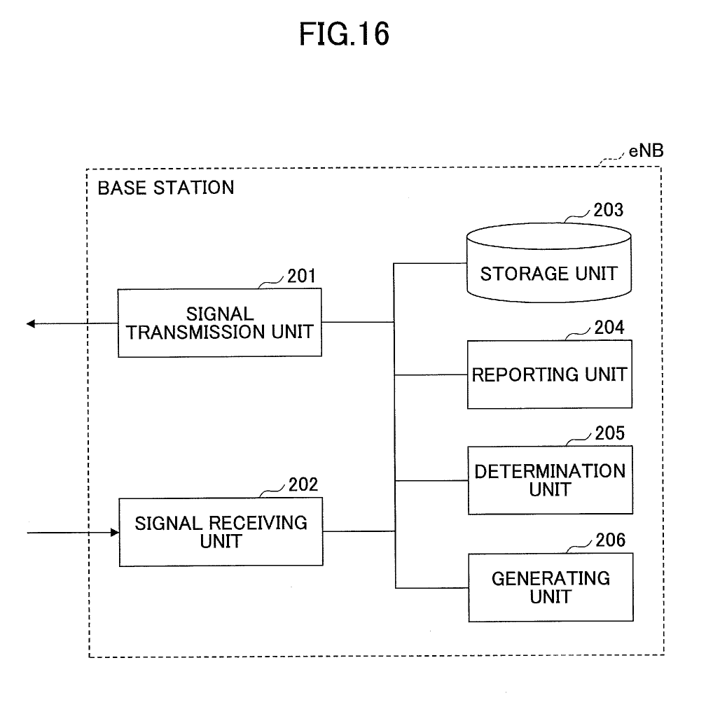

FIG. 16 is a diagram illustrating a functional configuration example of a base station according to an embodiment. As illustrated in FIG. 16, the base station eNB includes a signal transmission unit 201, a signal receiving unit 202, a storage unit 203, a reporting unit 204, a determination unit 205, and a generating unit 206. Note that FIG. 16 merely illustrates the functional configuration particularly related to the embodiment of the present invention in the base station eNB, and the base station eNB may also include not-illustrated functions for performing, at the least, operations in compliance with LTE. The functional configuration of the base station eNB illustrated in FIG. 16 is merely an example. Any functional division and any names of the functional components may be applied insofar as the operations according to the present embodiment may be executed.

The signal transmission unit 201 includes a function to generate various types of signals of the physical layer from the signals of a higher layer to be transmitted from the base station eNB and to wirelessly transmit the generated signals. The signal receiving unit 202 includes a function to receive various radio signals from the user apparatus UE and acquire signals of a higher layer from the received signals of the physical layer.

The storage unit 203 stores a transmission power pattern to be reported to the user apparatus UE. Note that the storage unit 203 may store a different transmission power pattern for each of the user apparatuses UE or may store a transmission power pattern in accordance with the capability (UE Capability) of each of the user apparatuses UE.

The reporting unit 204 acquires a transmission power pattern from the storage unit 203 and reports (transmits) the acquired transmission power pattern to the user apparatus UE via the signal transmission unit 201. Note that the reporting unit 204 may report a different transmission power pattern for each of the user apparatuses UE or may transmit a transmission power pattern in accordance with the capability (UE Capability) of each of the user apparatuses UE.

The determination unit 205 includes a function to determine whether the cell managed by the base station eNB itself is congested (crowded). The determination unit 205 may determine that the cell is congested in a case where the number of user apparatuses UE residing within the cell managed by the base station itself exceeds a predetermined threshold, or may determine that the cell is congested based on a report from the user apparatus UE. In a case where the determination unit 205 determines that the cell managed by the base station eNB itself is congested, the determination unit 205 may indicate to the reporting unit 204 that the reporting unit 204 reports the transmission power pattern to the user apparatus UE.

The generating unit 206 includes a function to generate a transmission power pattern to be reported (transmitted) to the user apparatus UE and store the generated transmission power pattern in the storage unit 203. The generating unit 206 may select the candidate transmission power value to be included in the transmission power pattern based on the information fed back from the user apparatus UE.

### Hardware Configuration

The block diagrams (FIGS. 15 and 16) used in the description of the above embodiment indicates blocks of functional units. These functional blocks (functional components) are implemented by any combination of hardware components or software components. The Components for implementing respective functional blocks are not particularly specified. That is, the functional blocks may be implemented by one physically and/or logically combined device or may be implemented by two or more physically and/or logically separated devices that are directly and/or indirectly connected (e.g., wired and/or wireless connections).

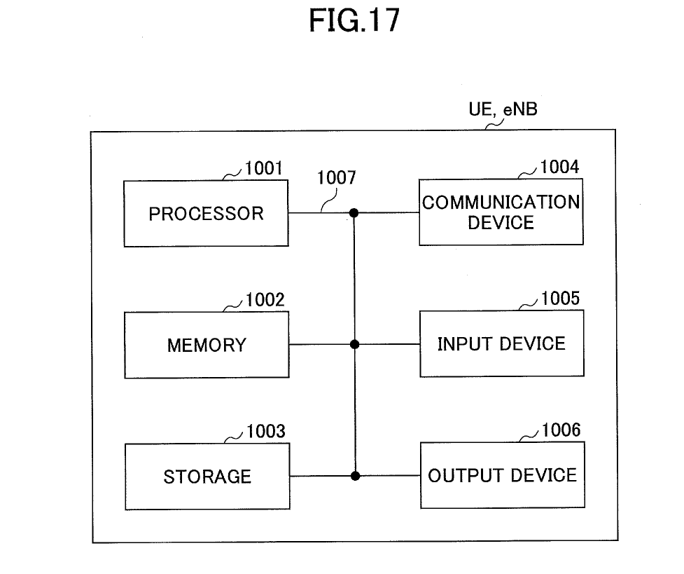

For example, the user apparatus UE and the base station eNB in an embodiment of the present invention may function as a computer that performs processes of a communication indication method or an indication method according to the present invention. FIG. 17 is a diagram illustrating an example of a hardware configuration of the user apparatus UE and the base station eNB in an embodiment of the present invention. Each of the base station eNB and the user apparatus UE described above may be physically configured as a computer device including a processor 1001, a memory 1002, a storage 1003, a communication device 1004, an input device 1005, an output device 1006, and a bus 1007.

In the following description, the term “device” may be replaced with a circuit, an apparatus, a unit, or the like. The hardware configuration of the user apparatus UE or the base station eNB may be configured to include one or more of the respective devices illustrated in FIG. 17 or may be configured without including some of the devices.

The functions of the user apparatus UE or the base station eNB are implemented by allowing predetermined software (programs) to be loaded on the hardware such as the processor 1001, the memory 1002, and the like, so as to cause the processor 1001 to perform calculations to control communications by the communication device 1004, and reading and/or writing of data in the storage 1003.

The processor 1001 may, for example, operate an operating system to control the entire computer. The processor 1001 may be configured to include a central processing unit (CPU) having an interface with peripherals, a control device, an operation device, and registers. For example, the signal transmission unit 101, the signal receiving unit 102, the determination unit 103 and the acquisition unit 104 of the user apparatus UE; and the signal transmission unit 201, the signal receiving unit 202, the storage unit 203, the reporting unit 204, the determination unit 205 and the generating unit 206 of the base station eNB may be implemented by the processor 1001.

In addition, the processor 1001 loads programs (program codes), software modules or data from the storage 1003 and/or the communication device 1004 into the memory 1002, and executes various processes according to the loaded programs, software modules or data. The programs are configured to cause a computer to execute at least a part of the operations described in the above embodiment. For example, the signal transmission unit 101, the signal receiving unit 102, the determination unit 103 and the acquisition unit 104 of the user apparatus UE; and the signal transmission unit 201, the signal receiving unit 202, the storage unit 203, the reporting unit 204, the determination unit 205 and the generating unit 206 of the base station eNB may be stored in the memory 1002 and implemented by a control program operated by the processor 1001. Other functional blocks may be implemented in similar manners. The above-described various processes are described as being executed by one processor 1001; however, these processes may be executed simultaneously or sequentially by two or more processors 1001. The processor 1001 may be implemented by one or more chips. Note that the program may be transmitted from the network via an electric communication line.

The memory 1002 may be a computer-readable recording medium composed of at least one of a ROM (Read Only Memory), an EPROM (Erasable Programmable ROM), an EEPROM (Electrically Erasable Programmable ROM), a RAM (Random Access Memory) and the like. The memory 1002 may be referred to as a register, a cache, a main memory (a main storage device), or the like. The memory 1002 may store executable programs (program codes), software modules, and the like for implementing a communication indication method according to the embodiment of the present invention.

The storage 1003 is a computer-readable recording medium composed, for example, of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, and a magnetic strip. The storage 1003 may be referred to as an auxiliary storage device. The above-described storage medium may be, for example, a database, a server, or another appropriate medium including the memory 1002 and/or the storage 1003.

The communication device 1004 is hardware (a transmitting-receiving device) for performing communications between computers via a wired and/or wireless network. The communication device 1004 may also be referred to as a network device, a network controller, a network card, a communication module, or the like. For example, the signal transmission unit 101 and the signal receiving unit 102 of the user apparatus UE, and the signal transmission unit 201 and the signal receiving unit 202 of the base station eNB may be implemented by the communication device 1004.

The input device 1005 is configured to receive an input from the outside. Examples of the input device include a keyboard, a mouse, a microphone, a switch, a button, and a sensor. The output device 1006 is configured to generate an output to the outside. Examples of the output device include a display, a speaker, and an LED lamp. Note that the input device 1005 and the output device 1006 may be integrated (e.g., a touch panel).

In addition, the respective devices such as the processor 1001 and the memory 1002 may be connected by a bus 1007 for mutually communicating information with one another. The bus 1007 may be composed of a single bus or may be composed of different buses between the devices.

Further, the user apparatus UE or the base station eNB may include hardware such as a microprocessor, a digital signal processor (DSP), an ASIC (Application Specific Integrated Circuit), a PLD (Programmable Logic Device), and an FPGA (Field Programmable Gate Array). Alternatively, a part or all of the functional blocks of the user apparatus UE or the base station eNB may be implemented by these hardware components. For example, the processor 1001 may be implemented with at least one of these hardware components.

### Overview

According to the embodiment disclosed above, a user apparatus in a radio communication system that supports D2D communications is provided. The user apparatus includes an acquisition unit configured to acquire, from a base station, transmission power information including a candidate transmission power value of a D2D signal; and a transmission unit configured to change transmission power at each of predetermined periods, based on the candidate transmission power value included in the transmission power information, for transmitting a D2D signal. The user apparatus UE having this configuration may be able to provide a technology capable of controlling interference in D2D communications.

The user apparatus may further include, as a unit of the predetermined period, one of the following: a subframe unit for transmitting the D2D signal, a unit for repeatedly transmitting an identical MAC PDU, and a resource pool unit for use in the D2D signal. Accordingly, the user apparatus UE may be enabled to change the transmission power of the D2D signal through various units.

In the user apparatus, the transmission power information may include multiple candidate transmission power values, and the transmission unit may change the transmission power in accordance with the candidate transmission power value selected from the multiple candidate transmission power values, at each of the predetermined periods to transmit the D2D signal. As a result, the user apparatus UE may randomly select the candidate transmission power value from the multiple candidate transmission power values, or may select the candidate transmission power value in the order in which the candidate transmission power values are set to transmit the D2D signal. That is, the transmission power of the D2D signal may be changed in various patterns.

In the user apparatus, the transmission unit may determine the transmission power of the D2D signal, transmitted via a D2D physical data channel, based on a setting value of D2D control information transmitted via a D2D physical control channel. As a result, the receiving end user apparatus UE may be enabled to estimate the actual transmission power of the D2D signal in the PSSCH for each of the switching periods from the setting value of the received SCI. In addition, the receiving end user apparatus UE may be enabled to determine a timing (subframe) of receiving the PSSCH, to estimate the path loss, and to estimate a distance between the transmitting end user apparatus UE and the receiving end user apparatus itself, on the basis of the estimated transmission power and transmission power pattern.

The user apparatus further includes a receiving unit configured to receive a D2D signal transmitted from another user apparatus; and a determination unit configured to measure the mean received power or an interference wave level of the D2D signal received by the receiving unit and to determine whether the measured mean received power or interference wave level exceeds a predetermined threshold.

In the user apparatus, the transmission unit may change the transmission power at each of the predetermined periods to transmit the D2D signal in a case where the determination unit has determined that the measured mean received power or interference wave level exceeds the predetermined threshold value. As a result, the user apparatus UE may be enabled to perform an operation to change the transmission power of the D2D signal at each of the predetermined periods only when the area surrounding the user apparatus UE itself is congested.

According to the embodiment disclosed above, a base station in a radio communication system that supports D2D communications is provided. The base station includes a storage unit configured to store transmission power information including a candidate transmission power value of a D2D signal; and a transmission unit configured to transmit the transmission power information to the user apparatus in order to cause the user apparatus to change, at each of predetermined periods, transmission power for transmitting the D2D signal. The base station eNB having this configuration may be enabled to provide a technology capable of controlling interference in D2D communications.

According to the embodiment disclosed above, a communication method to be executed by a user apparatus in a radio communication system that supports D2D communications is provided. The communication method includes acquiring, from a base station, transmission power information including a candidate transmission power value of a D2D signal; and changing transmission power at each of predetermined periods, based on the candidate transmission power value included in the transmission power information, for transmitting a D2D signal. The communication method having this configuration may be enabled to provide a technology capable of controlling interference in D2D communications.

According to the embodiment disclosed above, a communication indication method to be executed by a base station in a radio communication system that supports D2D communications is provided. The communication indication method includes storing transmission power information including a candidate transmission power value of a D2D signal; and transmitting the transmission power information to the user apparatus in order to cause the user apparatus to change, at each of predetermined periods, transmission power for transmitting the D2D signal. The communication indication method having this configuration may be enabled to provide a technology capable of controlling interference in D2D communications.

### Supplementary Description of Embodiment

The PSCCH in the embodiment may be another control channel insofar as the PSCCH is a control channel for transmitting control information (SCI etc.) for use in D2D communications. The PSSCH may similarly be another data channel insofar as the PSSCH is a data channel for transmitting data (MAC PDU, etc.) for use in D2D communications. The PSDCH may similarly be another data channel insofar as the PSDCH is a data channel for transmitting data (i.e., a discovery message) for use in the D2D communication of the D2D discovery. The method claims present elements of various steps in a sample order and are not limited to the specific order presented unless explicitly stated in the claims.

The apparatuses (user apparatus UE/base station eNB) according to an embodiment may include a CPU and a memory, may be realized by having a program executed by the CPU (processor), may be realized by hardware such as hardware circuitry in which the logic described in an embodiment is included, or may be realized by a mixture of a program and hardware.

The embodiments have been described as described above; however, the disclosed invention is not limited to these embodiments, and a person skilled in the art would understand various variations, modifications, replacements, or the like. Specific examples of numerical values have been used for encouraging understanding of the present invention; however, these numeric values are merely examples and, unless otherwise noted, any appropriate values may be used. In the above description, partitioning of items is not essential to the present invention. Provisions described in more than two items may be combined if necessary. Provisions described in one item may be applied to provisions described in another item (as long as they do not conflict). In a functional block diagram, boundaries of functional units or processing units do not necessarily correspond to physical boundaries of parts. Operations of multiple functional units may be physically performed in a single part, or operations of a single functional unit may be physically performed by multiple parts. The order of steps in the above described sequences and flowcharts according to an embodiment may be changed as long as there is no contradiction. For the sake of convenience, the user apparatus UE and the base station eNB have been described by using functional block diagrams. These apparatuses may be implemented by hardware, by software, or by combination of both. The software which is executed by a processor included in a user apparatus UE according to an embodiment and the software which is executed by a processor included in a base station eNB may be stored in a random access memory (RAM), a flash memory, a read-only memory (ROM), an EPROM, an EEPROM, a register, a hard disk drive (HDD), a removable disk, a CD-ROM, a database, a server, or any other appropriate recording medium.

In the embodiment, the transmission power pattern is an example of transmission power information. The PSSCH is an example of a D2D physical data channel. The PSCCH is an example of a D2D physical control channel. The SCI is an example of D2D control information.

The present application is based on and claims the benefit of priority of Japanese Priority Application No. 2015-172393 filed on Sep. 1, 2015, the entire contents of Japanese Priority Application No. 2015-172393 are hereby incorporated by reference.

### DESCRIPTION OF REFERENCE SIGNS

eNB base station
UE user apparatus
101 signal transmission unit
102 signal receiving unit
103 determination unit
104 acquisition unit
201 signal transmission unit
202 signal receiving unit
203 storage unit
204 reporting unit
205 determination unit
206 generating unit
1001 processor
1002 memory
1003 storage
1004 communication device
1005 input device
1006 output device

1. A user apparatus of a radio communication system that supports D2D communications, the user apparatus comprising:
an acquisition unit configured to acquire, from a base station, transmission power information including a candidate transmission power value of a D2D signal; and
a transmission unit configured to change transmission power at each of predetermined periods, based on the candidate transmission power value included in the transmission power information, for transmitting a D2D signal.

2. The user apparatus according to claim 1, wherein a unit of the predetermined period is one of a subframe unit for transmitting the D2D signal, a unit for repeatedly transmitting an identical MAC PDU, and a resource pool unit for use in the D2D signal.

3. The user apparatus according to claim 1, wherein
the transmission power information includes a plurality of candidate transmission power values, and
the transmission unit changes the transmission power in accordance with the candidate transmission power value selected from the plurality of candidate transmission power values at each of the predetermined periods to transmit the D2D signal.

4. The user apparatus according to claim 1, wherein the transmission unit determines the transmission power of the D2D signal, transmitted via a D2D physical data channel, based on a configured value of D2D control information transmitted via a D2D physical control channel.

5. The user apparatus according to claim 1, further comprising:
a receiving unit configured to receive a D2D signal transmitted from another user apparatus that differs from the user apparatus; and
a determination unit configured to measure mean received power or an interference wave level of the D2D signal received by the receiving unit and determine whether the measured mean received power or interference wave level exceeds a predetermined threshold, wherein
the transmission unit changes the transmission power at each of the predetermined periods to transmit the D2D signal when the determination unit determines that the measured mean received power or interference wave level exceeds the predetermined threshold value.

6. A base station of a radio communication system that supports D2D communications, the base station comprising:
a storage unit configured to store transmission power information including a candidate transmission power value of a D2D signal; and
a transmission unit configured to transmit the transmission power information to a user apparatus UE in order to cause the user apparatus UE to change, at each of predetermined periods, transmission power for transmitting the D2D signal.

7. A communication method executed by a user apparatus of a radio communication system that supports D2D communications, the communication method comprising:
acquiring, from a base station, transmission power information including a candidate transmission power value of a D2D signal; and
changing transmission power at each of predetermined periods, based on the candidate transmission power value included in the transmission power information, for transmitting a D2D signal.

8. A communication indication method executed by a base station of a radio communication system that supports D2D communications, the communication indication method comprising:
storing transmission power information including a candidate transmission power value of a D2D signal; and
transmitting the transmission power information to a user apparatus UE in order to cause the user apparatus UE to change, at each of predetermined periods, transmission power for transmitting the D2D signal.
